(19) United States
(12) Patent Application Publication
(10) Pub. No.: US 2021/0329207 A1
(43) Pub. Date: Oct. 21, 2021

(54) IMAGE DISPLAYING METHOD, APPARATUS AND ELECTRONIC DEVICE

(71) Applicant: AUTEL ROBOTICS CO., LTD., Shenzhen (CN)

(72) Inventor: Yinhua FENG, Shenzhen (CN)

(21) Appl. No.: 17/361,544

(22) Filed: Jun. 29, 2021

Related U.S. Application Data
(63) Continuation of application No. PCT/CN2019/129560, filed on Dec. 28, 2019.

(30) Foreign Application Priority Data
Dec. 29, 2018 (CN) 201811636868.5

(51) Int. Cl. H04N 9/64; H04N 7/18; H04N 5/235; B64C 39/02; B64D 47/08

(52) U.S. Cl. CPC H04N 9/646; H04N 7/18; H04N 5/2351; B64C 2201/127; B64C 39/024; B64D 47/08; B64C 2201/027; H04N 5/2353

(57) ABSTRACT

Embodiments of the present invention relate to an image displaying method, apparatus and electronic device. The image displaying method includes: acquiring brightness information of a current image; and adjusting a color of the current image or descriptive information according to the brightness information of the image, so that the color of the image and the color of the descriptive information have a preset degree of contrast. In the embodiments of the present invention, the color of the current image or the descriptive information of the image is adjusted according to the brightness information of the image, so that the color of the image matches the color of the descriptive information. In this way, a user can obtain a better viewing experience.

### CROSS REFERENCE

This application is a continuation of International Application No. PCT/CN2019/129560, filed on Dec. 28, 2019, which claims priority to Chinese Patent Application No. 2018116368685 filed on Dec. 29, 2018, which is incorporated herein by reference in its entirety.

### BACKGROUND

### Technical Field

Embodiments of the present invention relate to the technical field of unmanned aerial vehicles (UAV), and in particular, to an image displaying method, apparatus and electronic device.

### Related Art

With the development of UAV technologies, UAVs have been widely used in military and civilian fields. Through the technology, the UAV can be controlled through a variety of electronic devices such as a remote control, a personal smart phone, a personal PC and the like. In an implementation, the UAV transmits, to a screen of the electronic device, a video stream taken by its camera apparatus. The video stream may be an image of a surrounding environment taken by the UAV, and a user can determine the danger during flight of the UAV through the image to control the UAV. The electronic device may further display descriptive information such as texts, icons and the like in some regions of the image to provide explanations and alarms to the user.

During implementation of the present invention, it is found that at least the following problems in the related art. Since a color of the descriptive information such as texts and icons is fixed, generally set to white, when the ambient light is normal, a large color contrast exists between video images and the descriptive information, so that the user can obtain a better viewing experience. However, when the ambient light is strong, the color of the video image is whitish, which is basically consistent with the color of the descriptive information, and therefore it is difficult for the user to distinguish clearly and it is difficult to protect the eyes, resulting in a poor viewing experience.

### SUMMARY

An objective of embodiments of the present invention is to provide an image displaying method, apparatus and electronic device, which can cause colors of the image to match colors of descriptive information of the image, so that a user can obtain a better viewing experience.

In a first aspect, an embodiment of the present invention provides an image displaying method, applicable to an electronic device, the electronic device being communicatively connected to a UAV, the UAV including a camera apparatus, the electronic device including a display screen, the display screen being configured to display an image taken by the camera apparatus and descriptive information of the image, and the image displaying method including:

acquiring brightness information of a current image, where the brightness information of the current image indicates a light intensity of an environment in which the UAV is currently located and/or a brightness value of the current image; and

adjusting a color of the current image or the descriptive information according to the brightness information of the image, so that the color of the image and the color of the descriptive information have a preset degree of contrast.

In some embodiments, the brightness information of the current image includes an ambient light intensity, the ambient light intensity being the light intensity of the environment in which the UAV is located; and

the acquiring brightness information of a current image includes:

acquiring information about a location of the UAV;

acquiring, according to the information about the location of the UAV, a weather condition of the location of the UAV; and

acquiring the ambient light intensity according to the weather condition.

In some embodiments, the brightness information of the current image includes the brightness value of the current image; and

the acquiring brightness information of a current image includes:

performing analysis and processing on the image to obtain the brightness value of the current image.

In some embodiments, the adjusting a color of the current image or the descriptive information according to the brightness information of the image, so that the color of the image and the color of the descriptive information have a preset degree of contrast includes:

determining a display color parameter of the descriptive information according to the brightness information of the current image; and

adjusting a display color of the descriptive information on the display screen according to the display color parameter, so that the color of the image and the color of the descriptive information have the preset degree of contrast.

In some embodiments, the adjusting a color of the current image or the descriptive information according to the brightness information of the image, so that the color of the image and the color of the descriptive information have a preset degree of contrast includes:

determining an exposure parameter of the camera apparatus according to the brightness information of the current image; and

generating an exposure parameter adjustment instruction according to the exposure parameter, and transmitting the exposure parameter adjustment instruction to the UAV.

In some embodiments, the determining a display color parameter of the descriptive information according to the brightness information of the current image includes:

determining a range interval that the brightness information of the current image falls within, and determining the display color parameter of the descriptive information according to the range interval, where the range interval includes at least two range intervals, each of the range intervals having a corresponding display color parameter.

In some embodiments, the determining an exposure parameter of the camera apparatus according to the brightness information of the current image includes:

determining a range interval that the brightness information of the current image falls within, and determining the exposure parameter of the camera apparatus according to the range interval, where the range interval includes at least two range intervals, each of the range intervals having a corresponding exposure parameter.

In some embodiments, the method further includes:

displaying prompt information to warn a user about an excessively high image brightness if the ambient light intensity is greater than a preset light intensity threshold.

In a second aspect, an embodiment of the present invention provides an image displaying apparatus, applicable to an electronic device, the electronic device being communicatively connected to a UAV, the UAV including a camera apparatus, the electronic device including a display screen, the display screen being configured to display an image taken by the camera apparatus and descriptive information of the image, and the image displaying apparatus including:

a brightness acquisition module configured to acquire brightness information of a current image, where the brightness information of the current image indicates a light intensity of an environment in which the UAV is currently located and/or a brightness value of the current image; and

a color adjustment module configured to adjust a color of the current image or the descriptive information according to the brightness information of the image, so that the color of the image and the color of the descriptive information have a preset degree of contrast.

In some embodiments, the brightness information of the current image includes an ambient light intensity, the ambient light intensity being the light intensity of the environment in which the UAV is located; and

the brightness acquisition module is further configured to:

acquire information about a location of the UAV;

acquire, according to the information about the location of the UAV, a weather condition of the location of the UAV; and

acquire the ambient light intensity according to the weather condition.

In some embodiments, the brightness information of the current image includes the brightness value of the current image; and

the brightness acquisition module is further configured to:

perform analysis and processing on the image to obtain the brightness value of the current image.

In some embodiments, the color adjustment module includes a first color adjustment submodule. The first color adjustment submodule is configured to:

determine a display color parameter of the descriptive information according to the brightness information of the current image; and

adjust a display color of the descriptive information on the display screen according to the display color parameter, so that the color of the image and the color of the descriptive information have the preset degree of contrast.

In some embodiments, the color adjustment module includes a second color adjustment submodule. The second color adjustment submodule is configured to:

determine an exposure parameter of the camera apparatus according to the brightness information of the current image; and

generate an exposure parameter adjustment instruction according to the exposure parameter, and transmit the exposure parameter adjustment instruction to the UAV.

In some embodiments, the first color adjustment submodule is further configured to:

determine a range interval that the brightness information of the current image falls within, and determine the display color parameter of the descriptive information according to the range interval, where the range interval includes at least two range intervals, each of the range intervals having a corresponding display color parameter.

In some embodiments, the second color adjustment submodule is further configured to:

determine a range interval that the brightness information of the current image falls within, and determine the exposure parameter of the camera apparatus according to the range interval, where the range interval includes at least two range intervals, each of the range intervals having a corresponding exposure parameter.

In some embodiments, the apparatus further includes:

a prompt module, configured to display prompt information to warn a user about an excessively high image brightness if the ambient light intensity is greater than a preset light intensity threshold.

According to a third aspect, an embodiment of the present invention provides an electronic device, including:

a display screen;

at least one processor; and

a memory communicatively connected to the at least one processor, the memory storing instructions executable by the at least one processor, the instructions being executed by the at least one processor, to enable the at least one processor to perform the foregoing method.

In a fourth aspect, an embodiment of the present invention provides a non-volatile computer-readable storage medium storing computer-executable instructions, the computer-executable instructions, when executed by an electronic device, causing the electronic device to perform the foregoing method.

According to the image displaying method, apparatus and electronic device in the embodiments of the present invention, the color of the current image or the descriptive information of the image is adjusted according to the brightness information of the image, so that the color of the image and the color of the descriptive information have the preset degree of contrast. Therefore, the color of the image matches the color of the descriptive information, so as to provide a better viewing experience for the user.

### BRIEF DESCRIPTION OF THE DRAWINGS

One or more embodiments are exemplarily described with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic diagram of an application scenario of an image displaying method and apparatus according to an embodiment of the present invention.

FIG. 2 is a schematic flowchart of an embodiment of the image displaying method according to the present invention.

FIG. 3 is a schematic structural diagram of an embodiment of the image displaying apparatus according to the present invention.

FIG. 4 is a schematic structural diagram of an embodiment of the image displaying apparatus according to the present invention.

FIG. 5 is a schematic structural diagram of an embodiment of the image displaying apparatus according to the present invention.

FIG. 6 is a schematic structural diagram of an embodiment of the image displaying apparatus according to the present invention.

FIG. 7 is a schematic structural diagram of hardware of a controller in an embodiment of an electronic device according to the present invention.

### DETAILED DESCRIPTION

To make the objectives, technical solutions, and advantages of the embodiments of the present application clearer, the following clearly and completely describes the technical solutions in the embodiments of the present application with reference to the accompanying drawings in the embodiments of the present application. Apparently, the described embodiments are merely some embodiments of the present application rather than all of the embodiments. All other embodiments obtained by a person of ordinary skill in the art based on the embodiments of the present application without creative effects shall fall within the protection scope of the present application.

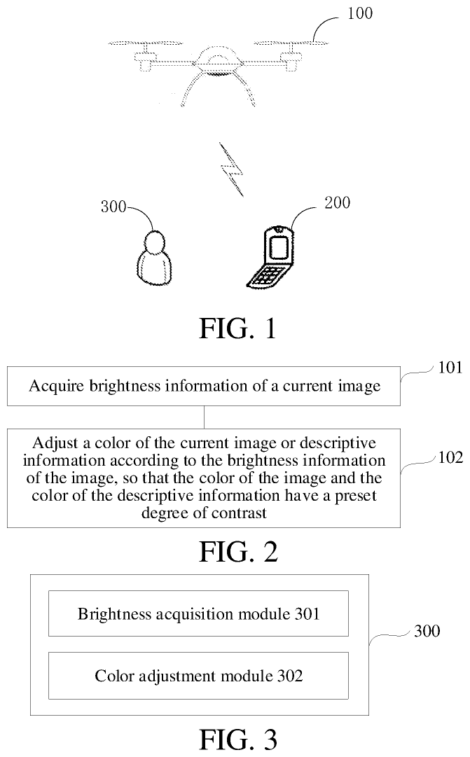

An image displaying method, apparatus and electronic device provided in the embodiments of the present invention are applicable to an application scenario shown in FIG. 1. The application scenario includes a UAV 100, an electronic device 200 and a user 300. The UAV 100 may be a suitable UAV, including a fixed-wing UAV and a rotary-wing UAV, such as a helicopter, a quadrotor and an aircraft with other numbers of rotors and/or rotor configuration. The UAV 100 may further be other movable objects, such as a manned aircraft, a model airplane, an unmanned airship, an unmanned hot air balloon and the like. The electronic device 200 may be, for example, a remote control, a smart phone, a tablet computer, a personal computer, a laptop computer and the like. The user 300 may interact with the electronic device 200 through any suitable type of one or more user interaction devices, and the user interaction devices may be a mouse, a button, a touch screen and the like. The UAV 100 and the electronic device 200 may establish a communication connection through a wireless communication module respectively provided therein, and upload or issue data/instructions.

The UAV 100 includes a body, arms connected to the body and a power apparatus. The power apparatus is configured to provide push force or lift force for the UAV 100 to fly. The UAV 100 further includes a camera apparatus disposed on the body and a controller of the camera apparatus for controlling the camera apparatus. The camera apparatus is, for example, a high-definition camera, a sport camera or the like. The camera apparatus is configured to take an image of a surrounding environment of the UAV 100. The electronic device 200 includes a display screen configured to display the image taken by the UAV 100. The image may be a video image or a picture. The user 300 can watch the image of the surrounding environment of the UAV through the electronic device 200 to determine whether the UAV 100 is in flight danger, so as to adjust a flight strategy of the UAV 100 in time.

The electronic device 200 may further display descriptive information such as texts, icons and the like in some regions of the image to provide explanations and alarms to the user. A color of the descriptive information may be set to any suitable color. When the color of the image matches the color of the descriptive information, that is, when there is a relatively large color contrast between the two colors, for example, when the descriptive information is white and the color of image is black with a certain degree of transparency, the viewing effect is better. The color of the image taken by the UAV 100 is closely related to the light intensity of the environment at that time. When the ambient light is normal, the image is black with a certain degree of transparency. When the ambient light is strong, the color of the image is white. Therefore, if the color of descriptive information is white, when the ambient light is normal, a large color contrast exists between the image and the descriptive information, so that the user can obtain a better viewing experience. However, when the ambient light is strong, the color of the image is basically consistent with the color of the descriptive information, and therefore it is difficult for the user to distinguish clearly and it is difficult to protect the eyes, resulting in a poor viewing experience.

In the embodiments of the present invention, the color of the current image or the descriptive information of the image is adjusted according to the brightness information of the image, so that the color of the image matches the color of the descriptive information. In this way, a user can obtain a better viewing experience.

It should be noted that, in addition to being used on the UAV 100, the above electronic device 200 may also be used in other occasions, for example, a photographing apparatus for shooting in a field environment.

FIG. 2 is a schematic flowchart of an image displaying method according to an embodiment of the present invention. The method may be used for the electronic device 200 shown in FIG. 1. As shown in FIG. 2, the method includes the following steps.

101: Acquire brightness information of a current image.

Brightness of the image is closely related to an ambient light intensity. When the ambient light intensity is relatively high, the brightness of the image is relatively high. When the ambient light intensity is relatively low, the brightness of the image is relatively low. Therefore, in some embodiments, the ambient light intensity is used to represent the brightness information of the current image. The ambient light intensity is the light intensity of a location of the UAV, which may be obtained according to a weather condition of the location of the UAV. Specifically, location information of the UAV may be obtained through a localization module (such as a GPS module) disposed on the UAV, and then the UAV transmits the location information to the electronic device. The electronic device determines the location of the UAV according to the location information (for example, the UAV is located in which district of which city), and then the electronic device is connected to the Internet to obtain the weather condition of the location. The weather condition is, for example, sunny, cloudy or light rain and about an intensity of ultraviolet rays, the ambient light intensity may be roughly determined according to the weather condition of the location of the UAV.

In some other embodiments, the brightness information of the current image may be the brightness value of the current image, and the brightness value of the current image may be directly obtained through analysis and calculation based on the image.

102: Adjust a color of the current image or the descriptive information according to the brightness information of the image, so that the color of the image and the color of the descriptive information have a preset degree of contrast.

The color of the image is closely related to the brightness of the image. When the brightness of the image is relatively high, the color of the image is relatively bright, and when the brightness of the image is relatively low, the color of the image is relatively dark. Therefore, the brightness information of the current image can be used to determine whether the color of the image is lighter or darker, so as to determine whether the color of the image matches the color of the descriptive information. Accordingly, the color of the image or the color of the descriptive information is adjusted, so that the color of the image matches the color of the descriptive information.

In some embodiments, the color of the image matches the color of the descriptive information by adjusting the color of the descriptive information. Specifically, a display color parameter of the descriptive information may be determined according to the brightness information of the current image, and then a display color of the descriptive information on the display screen is adjusted according to the display color parameter, so that the color of the image matches the color of the descriptive information. The color of the image matches the color of the descriptive information, that is, the color of the image and the color of the descriptive information are quite different (for example, one is white and the other is black), which is convenient for the user to watch. A degree of difference between the color of the image and the color of the descriptive information may be set in advance, for example, it is specified how much difference between the color values of the image and the descriptive information is allowed.

In some specific implementations, a plurality of range intervals may be set, each of the range intervals having a corresponding display color parameter, and then a range interval that the brightness information of the current image falls within is determined, so as to determine the display color parameter. The ambient light intensity is used to represent the brightness information of the current image by way of example. A plurality of light intensity ranges may be set, each of the light intensity ranges having a corresponding display color parameter. For example, the display color parameter corresponding to the light intensity range with a higher light intensity is black or other dark colors, and the display color parameter corresponding to the light intensity range with a lower light intensity is white or other light colors. By determining a light intensity range that the ambient light intensity falls within, the display color parameter of the descriptive information can be determined, so that the color of the image and the color of the descriptive information can have a larger contrast to match each other.

The brightness value of the current image is used to represent the brightness information of the current image by way of example. A plurality of brightness ranges may be set, each of the brightness ranges having a corresponding display color parameter. For example, the display color parameter corresponding to the brightness range with a higher brightness is black or other dark colors, and the display color parameter corresponding to the brightness range with a lower brightness is white or other light colors. By determining the brightness range that the brightness value of the current image falls within, the display color parameter of the descriptive information can be determined.

In some other embodiments, the color of the image matches the color of the descriptive information by adjusting the color of the image. Specifically, the color of the image can be adjusted by adjusting the exposure parameter of the camera apparatus. In actual use, the UAV may set the exposure parameter of the camera apparatus through the controller of the camera apparatus. The electronic device may determine the exposure parameter of the camera apparatus according to the brightness information of the current image, then generate an exposure parameter adjustment instruction according to the exposure parameter, and transmit the exposure parameter adjustment instruction to the controller of the camera apparatus.

In some specific implementations, a plurality of range intervals may be set, each of the range intervals having a corresponding exposure parameter, and then a range interval that the brightness information of the current image falls within is determined, so as to determine the exposure parameter. The exposure parameter is, for example, an exposure value, a color, white balance or the like. The ambient light intensity is used to represent the brightness information of the current image by way of example. A plurality of light intensity ranges may be set, each of the light intensity ranges having a corresponding exposure parameter. For example, the exposure parameter corresponding to the light intensity range with a higher light intensity tends to indicate less exposure, causing the image to be darker (for example, by setting a smaller exposure value, a darker color or a white balance mode to cause the image to be darker), and the exposure parameter corresponding to the light intensity range with a lower light intensity tends to indicate greater exposure, causing the image to be brighter (for example, by setting a larger exposure value, a brighter color or a white balance mode to cause the image to be brighter). By determining the light intensity range that the ambient light intensity falls within, the exposure parameter can be determined, so that the color of the image and the color of the descriptive information can have a larger contrast to match each other.

The brightness value of the current image is used to represent the brightness information of the current image by way of example. A plurality of brightness ranges may be set, each of the brightness ranges having a corresponding exposure parameter. For example, the exposure parameter corresponding to the brightness range with a higher brightness tends to indicate less exposure, causing the image to be darker (for example, by setting a smaller exposure value, a darker color or a white balance mode to cause the image to be darker), and the exposure parameter corresponding to the brightness range with a lower brightness tends to indicate greater exposure, causing the image to be brighter (for example, by setting a larger exposure value, a brighter color or a white balance mode to cause the image to be brighter). By determining the brightness range that the brightness value of the current image falls within, the exposure parameter can be determined.

In some other embodiments, when the ambient light intensity exceeds a preset light intensity threshold, the electronic device may further display prompt information on its display screen to warn a user about an excessively high image brightness. Further, the electronic device may further remind the user to manually modify the exposure parameter of the camera apparatus or the color of the descriptive information. In this way, damage to eyesight of the user can be avoided, and user experience can be further improved.

It is to be noted that, the embodiment of the present invention is more applicable to an outdoor environment. In order to avoid poor viewing effect caused by strong light, the color of the image or the descriptive information of the image is adjusted, so that the color of the image matches the color of the descriptive information. When the UAV is in an indoor environment, since the light is not strong, it is not necessary to adjust the color of the image or the descriptive information. In actual use, the electronic device may receive the location information transmitted by the UAV in real time. When the UAV is indoors, the electronic device cannot receive the location information transmitted by the UAV. The electronic device can determine, according the failure to receive the location information, that the UAV is indoors, and the color of the image or the descriptive information is not adjusted.

Correspondingly, as shown in FIG. 3, an embodiment of the present invention further provides an image displaying apparatus 300 used in the electronic device 200 in FIG. 1. The image displaying apparatus 300 includes:

a brightness acquisition module 301 configured to acquire brightness information of a current image, where the brightness information of the current image indicates a light intensity of an environment in which the UAV is currently located and/or a brightness value of the current image; and

a color adjustment module 302 configured to adjust a color of the current image or the descriptive information according to the brightness information of the image, so that the color of the image and the color of the descriptive information have a preset degree of contrast.

In the embodiments of the present invention, the color of the current image or the descriptive information of the image is adjusted according to the brightness information of the image, so that the color of the image matches the color of the descriptive information. In this way, a user can obtain a better viewing experience.

In some embodiments of the image displaying apparatus 300, the brightness information of the current image includes an ambient light intensity, the ambient light intensity being the light intensity of an environment in which the UAV is located; and

the brightness acquisition module 301 is further configured to:

acquire information about a location of the UAV;

acquire, according to the information about the location of the UAV, a weather condition of the location of the UAV; and

acquire the ambient light intensity according to the weather condition.

In some embodiments of the image displaying apparatus 300, the brightness information of the current image includes the brightness value of the current image; and

the brightness acquisition module 301 is further configured to:

perform analysis and processing on the image to obtain the brightness value of the current image.

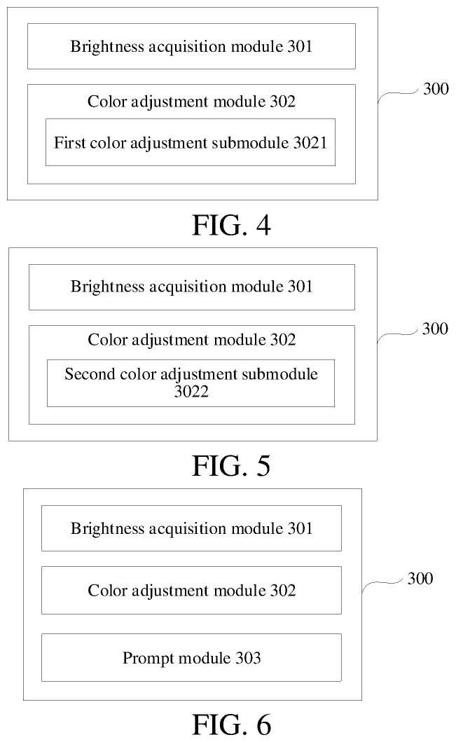

In some embodiments of the image displaying apparatus 300, as shown in FIG. 4, the color adjustment module 302 includes a first color adjustment submodule 3021. The first color adjustment submodule 3021 is configured to:

determine a display color parameter of the descriptive information according to the brightness information of the current image; and

adjust a display color of the descriptive information on the display screen according to the display color parameter, so that the color of the image and the color of the descriptive information have the preset degree of contrast.

In some embodiments of the image displaying apparatus 300, as shown in FIG. 5, the color adjustment module 302 includes a second color adjustment submodule 3022. The second color adjustment submodule 3022 is configured to:

determine an exposure parameter of the camera apparatus according to the brightness information of the current image; and

generate an exposure parameter adjustment instruction according to the exposure parameter, and transmit the exposure parameter adjustment instruction to the UAV.

In some embodiments of the image displaying apparatus 300, the first color adjustment submodule 3021 is further configured to:

determine a range interval that the brightness information of the current image falls within, and determine the display color parameter of the descriptive information according to the range interval, where the range interval includes at least two range intervals, each of the range intervals having a corresponding display color parameter.

In some embodiments of the image displaying apparatus 300, the second color adjustment submodule 3022 is further configured to:

determine a range interval that the brightness information of the current image falls within, and determine the exposure parameter of the camera apparatus according to the range interval, where the range interval includes at least two range intervals, each of the range intervals having a corresponding exposure parameter.

In some embodiments of the image displaying apparatus 300, as shown in FIG. 6, the image displaying apparatus 300 further includes:

a prompt module 303, configured to display prompt information to warn a user about an excessively high image brightness if the ambient light intensity is greater than a preset light intensity threshold.

It should be noted that, the foregoing apparatus may perform the method provided in the embodiments of the present application, and have the corresponding functional modules for performing the method and beneficial effects thereof. For technical details not described in detail in the apparatus embodiment, refer to the method provided in the embodiments of the present application.

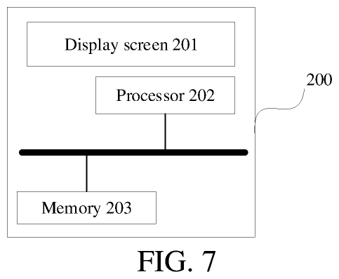

FIG. 7 is a schematic structural diagram of hardware of an electronic device 200. As shown in FIG. 7, the electronic device 200 includes:

one or more processors 202 and a memory 203. One processor 202 is used as an example in FIG. 7.

The processor 202 and the memory 203 may be connected by using a bus or in another manner. A connection by using the bus is used as an example in FIG. 7.

The memory 203, as a non-volatile computer-readable storage medium, may be configured to store a non-volatile software program, a non-volatile computer-executable program and a module, such as program instructions/modules (for example, the brightness acquisition module 301 and the color adjustment module 302 shown in FIG. 3) corresponding to the image displaying method in the embodiment of the present application. The processor 202 performs various functional applications and data processing of the electronic device by running the non-volatile software program, instructions and module stored in the memory 203, that is, implementing the image display method provided in the foregoing method embodiments.

The memory 203 may include a program storage area and a data storage area. The program storage area may store an operating system, an application program required by at least one function and the like. The data storage area may store data created according to use of the image sending terminal or the like. In addition, the memory 203 may include a high speed random access memory, and may also include a non-volatile memory, such as at least one magnetic disk storage device, a flash memory, or another volatile solid-state storage device. In some instances, the memory 203 may optionally include memories remotely disposed relative to the processor 202, and these remote memories may be connected to the electronic device through a network. Examples of the network include, but are not limited to, the Internet, an intranet, a local area network, a mobile communications network, and a combination thereof.

The one or more modules are stored in the memory 203. When executed by the one or more processors 202, the image displaying method in any of the above method embodiments is performed. For example, the above method step 101 to step 102 in FIG. 2 are performed, and functions of the modules 301-302 in FIG. 3, functions of the modules 301, 302 and 3021 in FIG. 4, functions of the modules 301, 302 and 3022 in FIG. 5 and functions of the modules 301-303 in FIG. 6 are implemented.

The foregoing product may perform the method provided in the embodiments of the present application, and have the corresponding functional modules for performing the method and beneficial effects thereof. For technical details not described in detail in this embodiment, refer to the method provided in the embodiments of the present application.

An embodiment of the present application provides a non-volatile computer-readable storage medium storing computer-executable instructions, the computer-executable instructions, when executed by one or more processors, for example, the processor 202 in FIG. 7, causing the one or more processors to perform the image displaying method in any of the foregoing method embodiments, for example, perform step 101 to step 102 in the foregoing method in FIG. 2, and implement functions of the modules 301-302 in FIG. 3, functions of the modules 301, 302 and 3021 in FIG. 4, functions of the modules 301, 302 and 3022 in FIG. 5 and functions of the modules 301-303 in FIG. 6.

The foregoing described device embodiments are merely examples. The units described as separate parts may or may not be physically separate, and the parts displayed as units may or may not be physical units, may be located in one position, or may be distributed on a plurality of network units. Some or all of the modules may be selected according to actual needs to achieve the objectives of the solutions of the embodiments.

Through the description of the foregoing embodiments, a person skilled in the art may clearly understand that the embodiments may be implemented by software in combination with a universal hardware platform, and may certainly be implemented by hardware. A person of ordinary skill in the art may understand that, all or some of the processes of the method in the foregoing embodiments may be implemented by a computer program instructing relevant hardware. The program may be stored in a computer-readable storage medium. During execution of the program, the processes of the foregoing method embodiments may be included. The foregoing storage medium may be a magnetic disk, an optical disc, a read-only memory (ROM), a random access memory (RAM) or the like.

Finally, it should be noted that the foregoing embodiments are merely used for describing the technical solutions of the present invention, but are not intended to limit the present invention. Under the concept of the present invention, the technical features in the foregoing embodiments or different embodiments may be combined, the steps may be implemented in any sequence, and there may be many other changes in different aspects of the present invention as described above. For brevity, those are not provided in detail. Although the present invention is described in detail with reference to the foregoing embodiments, a person of ordinary skill in the art should understand that they may still make modifications to the technical solutions described in the foregoing embodiments or make equivalent replacements to some technical features thereof, without departing from the scope of the technical solutions of the embodiments of the present invention.

What is claimed is:

1. An image displaying method, applicable to an electronic device, the electronic device being communicatively connected to an unmanned aerial vehicle (UAV), the UAV comprising a camera apparatus, the electronic device comprising a display screen, the display screen being configured to display an image taken by the camera apparatus and descriptive information of the image, and the image displaying method comprising:
acquiring brightness information of a current image, wherein the brightness information of the current image indicates a light intensity of an environment in which the UAV is currently located and/or a brightness value of the current image; and
adjusting a color of the current image or the descriptive information according to the brightness information of the image, so that the color of the image and the color of the descriptive information have a preset degree of contrast.

2. The image displaying method according to claim 1, wherein the brightness information of the current image comprises an ambient light intensity, the ambient light intensity being the light intensity of the environment in which the UAV is located; and
the acquiring brightness information of a current image comprises:
acquiring information about a location of the UAV;
acquiring, according to the information about the location of the UAV, a weather condition of the location of the UAV; and
acquiring the ambient light intensity according to the weather condition.

3. The image displaying method according to claim 1, wherein the brightness information of the current image comprises the brightness value of the current image; and
the acquiring brightness information of a current image comprises:
performing analysis and processing on the image to obtain the brightness value of the current image.

4. The image displaying method according to claim 1, wherein the adjusting a color of the current image or the descriptive information according to the brightness information of the image, so that the color of the image and the color of the descriptive information have a preset degree of contrast comprises:
determining a display color parameter of the descriptive information according to the brightness information of the current image; and
adjusting a display color of the descriptive information on the display screen according to the display color parameter, so that the color of the image and the color of the descriptive information have the preset degree of contrast.

5. The image displaying method according to claim 1, wherein the adjusting a color of the current image or the descriptive information according to the brightness information of the image, so that the color of the image and the color of the descriptive information have a preset degree of contrast comprises:
determining an exposure parameter of the camera apparatus according to the brightness information of the current image; and
generating an exposure parameter adjustment instruction according to the exposure parameter, and transmitting the exposure parameter adjustment instruction to the UAV.

6. The image displaying method according to claim 4, wherein the determining a display color parameter of the descriptive information according to the brightness information of the current image comprises:
determining a range interval that the brightness information of the current image falls within, and determining the display color parameter of the descriptive information according to the range interval, wherein the range interval comprises at least two range intervals, each of the range intervals having a corresponding display color parameter.

7. The image displaying method according to claim 5, wherein the determining an exposure parameter of the camera apparatus according to the brightness information of the current image comprises:
determining a range interval that the brightness information of the current image falls within, and determining the exposure parameter of the camera apparatus according to the range interval, wherein the range interval comprises at least two range intervals, each of the range intervals having a corresponding exposure parameter.

8. The image displaying method according to claim 2, further comprising:
displaying prompt information to warn a user about an excessively high image brightness if the ambient light intensity is greater than a preset light intensity threshold.

9. An image displaying apparatus, applicable to an electronic device, the electronic device being communicatively connected to a UAV, the UAV comprising a camera apparatus, the electronic device comprising a display screen, the display screen being configured to display an image taken by the camera apparatus and descriptive information of the image, and the image displaying apparatus comprising:
a processor configured to: acquire brightness information of a current image, wherein the brightness information of the current image indicates a light intensity of an environment in which the UAV is currently located and/or a brightness value of the current image; and
adjust a color of the current image or the descriptive information according to the brightness information of the image, so that the color of the image and the color of the descriptive information have a preset degree of contrast.

10. The image displaying apparatus according to claim 9, wherein the brightness information of the current image comprises an ambient light intensity, the ambient light intensity being the light intensity of the environment in which the UAV is located; and
the processor is further configured to:
acquire information about a location of the UAV;
acquire, according to the information about the location of the UAV, a weather condition of the location of the UAV; and
acquire the ambient light intensity according to the weather condition.

11. The image displaying apparatus according to claim 9, wherein the brightness information of the current image comprises the brightness value of the current image; and
the processor is further configured to:
perform analysis and processing on the image to obtain the brightness value of the current image.

12. The image displaying apparatus according to claim 9, wherein the processor is further configured to:
determine a display color parameter of the descriptive information according to the brightness information of the current image; and
adjust a display color of the descriptive information on the display screen according to the display color parameter, so that the color of the image and the color of the descriptive information have the preset degree of contrast.

13. The image displaying apparatus according to claim 9, wherein the processor is further configured to:
determine an exposure parameter of the camera apparatus according to the brightness information of the current image; and
generate an exposure parameter adjustment instruction according to the exposure parameter, and transmit the exposure parameter adjustment instruction to the UAV.

14. The image displaying apparatus according to claim 12, wherein the processor is further configured to:
determine a range interval that the brightness information of the current image falls within, and determine the display color parameter of the descriptive information according to the range interval, wherein the range interval comprises at least two range intervals, each of the range intervals having a corresponding display color parameter.

15. The image displaying apparatus according to claim 13, wherein the processor is further configured to:
determine a range interval that the brightness information of the current image falls within, and determine the exposure parameter of the camera apparatus according to the range interval, wherein the range interval comprises at least two range intervals, each of the range intervals having a corresponding exposure parameter.

16. The image displaying apparatus according to claim 10, wherein the processor is further configured to display prompt information to warn a user about an excessively high image brightness if the ambient light intensity is greater than a preset light intensity threshold.

17. An electronic device, comprising:
a display screen;
at least one processor; and
a memory communicatively connected to the at least one processor, the memory storing instructions executable by the at least one processor, the instructions, when executed by the at least one processor, causing the at least one processor to:
acquire brightness information of a current image, wherein the brightness information of the current image indicates a light intensity of an environment in which the UAV is currently located and/or a brightness value of the current image; and
adjust a color of the current image or the descriptive information according to the brightness information of the image, so that the color of the image and the color of the descriptive information have a preset degree of contrast.

18. A non-volatile computer-readable storage medium, storing computer-executable instructions, the computer-executable instructions, when executed by an electronic device, causing the electronic device to:
acquire brightness information of a current image, wherein the brightness information of the current image indicates a light intensity of an environment in which the UAV is currently located and/or a brightness value of the current image; and
adjust a color of the current image or the descriptive information according to the brightness information of the image, so that the color of the image and the color of the descriptive information have a preset degree of contrast.
